(19) United States
(12) Patent Application Publication
(10) Pub. No.: US 2007/0079650 A1
(43) Pub. Date: Apr. 12, 2007

(54) Method and apparatus for checking the tightness of a tank system, in particular of a motor vehicle

(76) Inventors: Martin Streib, Vaihingen (DE); Karl-Bernhard Lederle, Renningen (DE); Michael Pfeil, Schwieberdingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/544,728

(22) Filed: Oct. 10, 2006

(30) Foreign Application Priority Data
Oct. 10, 2005 (DE) 10 2005 048 348.8

(51) Int. Cl. G01M 3/34; G01M 19/00

(52) U.S. Cl. 73/49.3; 73/118.1

(57) ABSTRACT

A method of and an apparatus for checking the tightness of a tank system of an internal combustion engine of a motor vehicle by means of overpressure or underpressure, in which a first controllable valve is disposed in a connection between the tank system and an overpressure or underpressure source, and a second controllable valve is disposed in a connection of the tank system with the ambient air in which the leak testing is performed at the end of a phase of operation of the engine, in particular at the end of a travel mode, of a motor vehicle that has the engine, and a demand for shutoff of the engine is executed with a time delay, and at least the steps of the leak testing that generate the overpressure or underpressure are performed within the delay time.

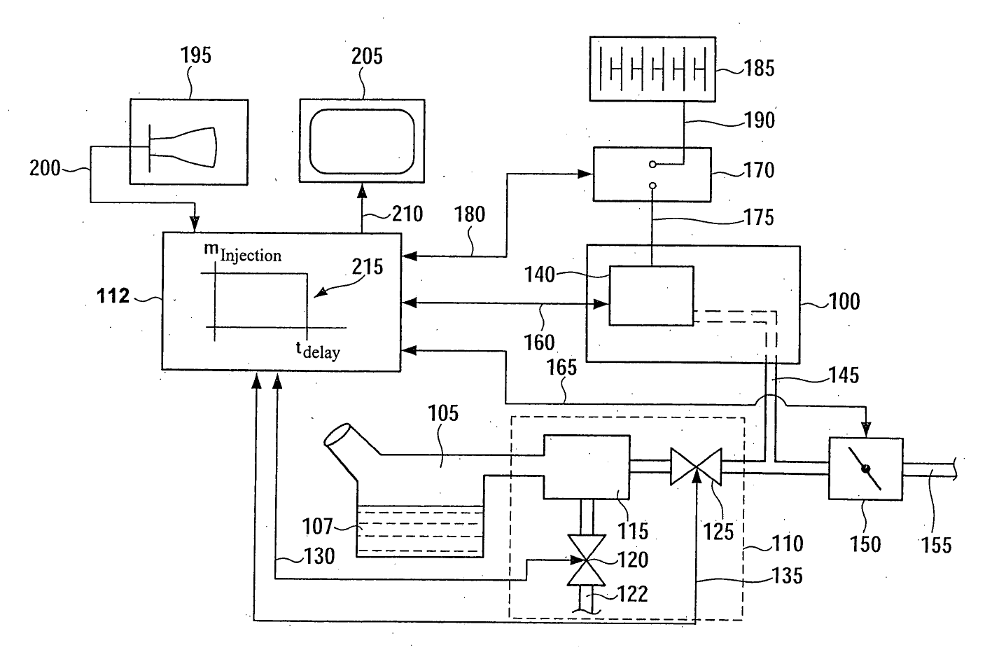

### REFERENCE TO FOREIGN PATENT APPLICATION

This application is based on German Patent Application No. 10 2005 048 348.8 filed 10 Oct. 2005, upon which priority is claimed.

### BACKGROUND OF THE INVENTION

1. Field of the Invention

The invention relates to a method of and an apparatus for checking the tightness of a tank system, in particular of a motor vehicle.

2. Description of the Prior Art

Motor vehicles of the type involved here are operated by combustion and have a fuel tank or corresponding tank system and a monitoring device for monitoring and optionally preventing the emission of fuel vapors formed in the fuel tank. The monitoring device serves in particular to catch any fuel vapor that occurs by means of an activated charcoal trap or activated charcoal filter (ACF) and temporarily store it in the activated charcoal trap.

Volatile fuel vapors, which are usually hydrocarbon vapors, are formed for instance while the motor vehicle tank is being filled, in the travel mode of the motor vehicle because of sloshing motions of the fuel in the fuel tank, or because of an increasing fuel temperature in the tank, with the attendant increase in the fuel vapor pressure.

The storage capacity of the aforementioned activated charcoal trap decreases steadily as the quantity of stored hydrocarbon increases, and it is therefore necessary to regenerate the activated charcoal trap from time to time, or in other words to dissolve the stored hydrocarbon back out of it again. For that purpose, the motor vehicles in question here have a tank venting system, in which the activated charcoal trap communicates via a tank venting valve (TVV), with an intake tube for aspirating combustion air via a throttle valve (TV) with the combustion chamber of the engine. By opening the TVV, a pressure gradient is created between the activated charcoal trap and the intake tube, and by means of it the hydrocarbon stored in the activated charcoal trap is carried into the intake tube in order to be combusted finally in the engine and thus disposed of in a way that is nonpolluting.

In the present context, reference is made to the more-stringent legal regulations valid for instance in California, which require that motor vehicles in which volatile fuels such as gasoline are used have a monitoring device, of the kind described at the outset, that is capable of detecting any existing leak 0.5 mm in size in the tank, or in the entire fuel tank system, solely with on-board means.

This kind of method and apparatus for detecting leaks in a tank system of the kind noted here is known from German Patent Disclosure DE 101 43 327 A1. In the method described there, while the engine is idling, the ventilation of the tank system on the fresh-air side of the ACF is first closed by means of an ACF blocking valve, and via the TVV, by means of the underpressure existing in the intake tube of the engine during idling, fuel vapors are aspirated from the tank system, so that there, an underpressure is created compared to the ambient pressure. Once a defined underpressure level has been reached, the TVV is also closed. If the tank system is intact, the existing underpressure continues to be stored permanently in the tank or in the tank system. If there are leaks, and also because of the aforementioned evaporation effects of the fuel, this underpressure decreases again even if the valves are closed, and from the pressure increase detected by means of a pressure sensor (that is, the reduction in the underpressure), it can be concluded that leaks are present.

The known methods for the leak testing in question here require relatively long idling phases of the engine in order to be able to make reliable statements about the tightness of the tank system. As soon as the motor vehicle begins to move, evaporations and condensations of fuel develop because of the aforementioned sloshing effects and may conceal pressure changes caused by a leak.

The aforementioned legal regulations in the United States moreover require a minimum frequency in actual operation of the motor vehicle for all leak diagnoses. Since the real idling phases are often shorter than the measurement times required for the leak testing, it can happen that this legal requirement cannot be met in many motor vehicles.

### OBJECT AND SUMMARY OF THE INVENTION

The invention is based on the concept of performing the leak testing described at the outset at the end of a phase of operation of the engine, in particular a travel mode of a motor vehicle that has the engine. After a demand expressed by the vehicle driver or by means of the ignition key has been made for shutting off the engine or the motor vehicle, this shutoff demand is not carried out until after a time delay, and at least the steps of the aforementioned leak testing that generate the underpressure are performed within this delay time.

The point of departure is based in particular on the recognition that is highly unlikely for a driver, immediately after a demand for shutoff of the motor vehicle expressed with the ignition key, to want to drive on again. As a rule, one can therefore assume that the ensuing stopped time of the motor vehicle suffices to be able to perform a leak testing or the aforementioned steps for generating the underpressure.

It should be noted that performing the leak testing at the end of a travel mode of a motor vehicle that has the engine is preferred only to the extent that the present invention can be implemented, for instance in hybrid or start-stop vehicles, in such a way that even before the trip ends, a motor shutoff phase is initiated in delayed fashion in such a way that the leak testing is still performed during the travel mode of the vehicle, at the end of the aforementioned phase of operation of the engine.

In a preferred embodiment of the method of the invention, within this delay time, the first part of the leak testing that generates the underpressure is performed in such a way that the ACF shutoff valve is closed and the TVV is opened. As soon as an underpressure necessary for the leak testing is reached, the TVV is closed and the engine is turned off, since the engine is no longer needed for generating the underpressure. The second part of the leak testing follows, namely the aforementioned detection and evaluation of the pressure increase, and preferably the gradient over time of the pressure increase. The second part of the leak testing accordingly preferentially takes place without operation of the engine or outside the travel mode of the motor vehicle.

As an alternative to a delayed shutoff of the engine, the “dieseling” that naturally occurs in most engines after the engine is shut off can also be utilized for the aforementioned diagnostic purpose, so that a leak testing can be performed even whenever the engine is not to be operated further after the driver has expressed a shutoff demand. The term “dieseling” is understood to mean the after-running phase of the engine because of its kinetic energy when the injection/ignition has been shut off. This is because after the shutoff of an internal combustion engine, an underpressure usually still exists in an intake tube disposed on the engine and can be utilized to generate at least a certain underpressure in the tank system of the motor vehicle. This “dieseling effect” can additionally be further reinforced or amplified by a closure of a throttle valve disposed on the engine.

This alternative, however, has the disadvantage compared to the embodiment mentioned previously that by way of the open TVV, hydrocarbon (HC) vapors can flow into the intake tube and can no longer be combusted because the engine has already been shut off, causing the allowable HC emissions limits to be exceeded. This disadvantage can be eliminated, however, by providing that the intake tube has its own ACF, or uses an ACF in common with the tank system, to prevent possible emissions from the intake tube into the environment.

The time delay in the physical shutoff of the engine preferably amounts to from 1-5 seconds. In order for the driver of the motor vehicle not to be made uncertain by the delayed shutoff of the engine, it can additionally be provided that a suitable statement is displayed, such as “diagnosis active; delayed engine shutoff”. This display can be made either in an existing vehicle dashboard or by means of a separate monitor.

The procedure according to the invention offers the advantage that the leak testing can be performed with the legally required frequency or regularity, without requiring expensive modifications of the engine or the motor vehicle, and thus the legally required frequency of diagnosis can be adhered to with this method in every case.

It should be noted that instead of the method described at the outset, similar diagnostic methods or others based on the aforementioned underpressure principle or an overpressure principle can be employed, as long as they make use of a mode of operation of the engine as described herein or a similar mode of operation, to enable performing a leak testing of the kind in question here. In the case of an overpressure principle, the tank system is subjected to an overpressure, and the pressure reduction that occurs as a result of a leak is detected and evaluated.

The apparatus according to the invention for implementing the aforementioned function sequences in the leak testing advantageously requires only slight modifications in an existing internal combustion engine or motor vehicle.

For instance, in a first embodiment, the apparatus includes a slightly modified electric cabling of the motor vehicle, as a result of which the voltage supply to electrically operated engine components, such as injection valves and ignition coils, is still assured even if the ignition key is already in the “stop” position.

In a second embodiment, preferably in a motor vehicle or engine that has an electronically controlled ignition key, the mode of operation of the electronic ignition key is reprogrammed in such a way that after the ignition key is turned to the “stop” position, a delayed shutoff of the engine takes place.

The apparatus of the invention further includes a control unit, or a control program disposed in such a control unit, by means of which the actual (physical) shutoff of the engine takes place only after a delayed shutoff time, for instance by the specification of an injection quantity of “0”.

In a further embodiment, the apparatus of the invention has a voltage supply or a voltage supply relay, by means of which the injection valves and/or the ignition coils are disconnected from the voltage supply after the delayed shutoff time.

It is understood that the invention can advantageously be employed not only in the automotive field but in all fields in which tank systems must be kept free of volatile substances in the manner described at the outset. The field of petrochemicals can be named, as only one example.

### BRIEF DESCRIPTION OF THE DRAWING

The invention will be better understood and further objects and advantages thereof will become more apparent from the ensuing detailed description of a preferred embodiment taken in conjunction with the sole drawing FIGURE which shows a combined block/function diagram for illustrating the method and apparatus of the invention for checking the tightness of a tank system of the kind in question.

### DESCRIPTION OF THE PREFERRED EMBODIMENT

The combined function/block diagram shown in the drawing illustrates a preferred exemplary embodiment of the method of the invention and the apparatus of the invention for checking the tightness of a tank system 105-125 of an internal combustion engine 100 of a motor vehicle (the latter not shown). The diagram includes a fuel tank 105 for supplying fuel 107 and an activated charcoal filter (ACF) 115, which communicates with the ambient air via an activated charcoal filter blocking valve (ACF shutoff valve) 120 which is controllable via a first control line 130, and via an exhaust line 122. The ACF 115 furthermore communicates with an intake tube 145 of the engine 100, via a tank venting valve (TVV) 125 that is controllable via a second control line 135. The intake tube 145 likewise communicates with the ambient air via a throttle valve (TV) 150 and an intake or lead line 155.

With the dashed line 110, those components which are to be associated with the tank venting system described at the outset are indicated.

The block diagram further includes a control unit 112 for in this case simultaneously controlling the engine 100 and the tank venting system 110 and for performing the leak testing of the invention. However, it is understood that the control of the tank venting system 110 and/or the performance of the leak testing may also be implemented in a separate control unit or the like. To that end, the control unit 112 is connected to the two control lines 130, 135 mentioned.

Via a third control line 160, the control unit 112 is in signal-carrying communication with injection valves 140, shown only schematically, of the engine 100 and, via a fourth control line 180, with a switch relay 170. The switch relay 170 is connected to the injection valves 140 on one side via an electric line 175. On the other side, the switch relay 170 is connected to a voltage supply 185, such as a vehicle battery, via an electric line 190. It is understood that the switch relay 170 is merely preferable, and its function may alternatively be implemented by a transistor switch or the like.

According to the invention, the control unit 112 is in signal-carrying communication, via a fifth control line 200, with an ignition key 195 for driver input of a demand for shutoff of the engine 100. In the present exemplary embodiment, a display unit 205 is additionally disposed in the passenger compartment (for instance in the dashboard) and communicates with the control unit 112 via a sixth control line 210. It should be stressed that this display unit is not absolutely necessary, since the method of the invention for leak testing can also be performed, with the aforementioned advantages, even without this display unit 205.

In the present exemplary embodiment, the entire leak testing, as already mentioned, is controlled by the control unit 112, specifically with the following work steps. By means of the ignition key 195, the control unit 112 detects that the driver wishes to shut off the engine 100 or the motor vehicle. The switch relay 170 is triggered by the control unit 112 in such a way that the engine 100 and in particular the injection valves 140 continue to be connected to the voltage supply 185, despite the “stop” position of the ignition key 195. This maintaining of the voltage supply is done within a delay time 215, which can be ascertained empirically and preferably amounts to between 1 and 5 seconds, calculated from the instant of the “stop” signal furnished by the ignition key 195 via the fifth control line 200. In other words, the shutoff demand expressed by the driver is executed with a time delay.

Within the delay time 215, in the present exemplary embodiment, the part of the leak testing that generates the underpressure is performed; the ACF shutoff valve 120 is closed and the TVV 125 is opened, so that the engine 100 that is “running on” generates an underpressure via the intake tube 145 in the tank system 105, including the ACF 115 and the corresponding lead lines and outgoing lines. As soon as a minimum underpressure required for the leak testing is reached, the TVV 125 is closed and the engine 100 is shut off entirely; that is, the switch relay 170 interrupts the voltage supply, of the injection valves 140 in particular. Next, the second part of the leak testing is performed; the pressure increase in the tank system 105 including the ACF 115 and the corresponding lead lines and outgoing lines is detected in a manner known per se by means of a pressure sensor (not shown), and the pressure increase and preferably its gradient over time is evaluated.

During the delay time, the control unit 112 generates the following statement to the driver, merely as an example, on the display unit 205: “A leak testing is currently being performed; your demand for shutoff of the motor is therefore being carried out with a time delay.”

In another exemplary embodiment, the leak testing is also performed at the end of a phase of operation of the engine 100, and preferably at the end of the travel mode of the motor vehicle. Unlike the above-described exemplary embodiment, however, the driver's shutoff demand of the driver is not reacted to with a delay, but instead, during the intrinsic dieseling of the engine 100, the attempt is made to utilize the underpressure produced so as to perform the aforementioned first part of the leak testing. For the reasons given at the outset, in this exemplary embodiment, a filter element (not shown in the drawing) disposed on the intake tube 145 of the engine 100 is preferably provided, by means of which possible emissions from the intake tube 145 into the ambient air are reduced or prevented.

The foregoing relates to preferred exemplary embodiments of the invention, it being understood that other variants and embodiments thereof are possible within the spirit and scope of the invention, the latter being defined by the appended claims.

We claim:

1. A method for checking the tightness of a tank system of an internal combustion engine by means of overpressure or underpressure, in which a first controllable valve is disposed in a connection between the tank system and an overpressure or underpressure source, and a second controllable valve is disposed in a connection of the tank system with the ambient air, the method comprising performing the leak testing at the end of a phase of operation of the engine, executing a demand for shutoff of the engine with a time delay during which time delay at least the part of the leak testing that generates the overpressure or underpressure is performed or at least begun.

2. The method as defined in claim 1, wherein the internal combustion is employed in a motor vehicle, and wherein the leak detecting is performed at the end of a travel mode of operation of the vehicle.

3. The method as defined by claim 2, wherein within the delay time, the first part of the leak testing that generates the overpressure or underpressure is performed in such a way that the second controllable valve is closed and the first controllable valve is opened; wherein as soon as an overpressure or underpressure necessary for the leak testing is reached, the second controllable valve is closed and the engine is shut off; and wherein following that, the second part of the leak testing is performed, and the pressure drop or pressure increase is detected and evaluated.

4. The method as defined by claim 2, wherein the delay time amounts to from 1 to 10 seconds, preferably 1 to 5 seconds.

5. The method as defined by claim 3, wherein the delay time amounts to from 1 to 10 seconds, preferably 1 to 5 seconds.

6. The method as defined by claim 4, comprising the further step of displaying an indication that the leak testing is being performed during the time delay, and the demand for shutoff of the engine is carried out with a time delay.

7. The method as defined by claim 4, comprising the further step of displaying an indication that the leak testing is being performed during the time delay, and the demand for shutoff of the engine is carried out with a time delay.

8. A method for checking the tightness of a tank system of an internal combustion engine of a motor vehicle by means of overpressure or underpressure, in which a first controllable valve is disposed in a connection between the tank system and a pressure source, and a second controllable valve is disposed in a connection of the tank system with the ambient air, the method comprising performing the leak testing at the end of a travel mode of operation of a motor vehicle that has the engine, and at least the part of the leak testing that generates the overpressure or underpressure is performed during an after-running phase (dieseling) of the engine.

9. The method as defined by claim 8, wherein the pressure buildup or pressure reduction during the after-running phase is reinforced or amplified by closing of a throttle valve disposed on the engine.

10. An apparatus for checking the tightness of a tank system of an internal combustion engine by means of overpressure or underpressure, the apparatus comprising a first controllable valve disposed in a connection between the tank system and an overpressure or underpressure source, a second controllable valve in a connection of the tank system with the ambient air, user input means for inputting a demand for shutoff of the engine, a modified electrical cabling and/or control of the engine operable to maintain the voltage supply of electrically operated components of the engine that are required for combustion even after the user input means for inputting a demand for shutoff of the engine are in the “OFF” position, and control means for activating at least the part of the leak testing that generates the overpressure or underpressure, after a demand for shutoff of the engine is input by means of the user input means.

11. The apparatus as defined by claim 10, further comprising by means for delayed shutoff of the engine beyond a predeterminable shutoff time after the shutoff demand is carried out.

12. The apparatus as defined by claim 10, wherein the engine is a fuel injection engine, and wherein the means for delayed shutoff of the engine perform the delayed shutoff by specification of an injection quantity “0”.

13. The apparatus as defined by claim 10, further comprising a voltage supply relay, the electrically operated components of the engine that are required for combustion being disconnected from the voltage supply by means of the voltage supply relay after the delayed shutoff time.

14. The apparatus as defined by claim 11, further comprising a voltage supply relay, the electrically operated components of the engine that are required for combustion being disconnected from the voltage supply by means of the voltage supply relay after the delayed shutoff time.

15. The apparatus as defined by claim 12, further comprising a voltage supply relay, the electrically operated components of the engine that are required for combustion being disconnected from the voltage supply by means of the voltage supply relay after the delayed shutoff time.

16. An apparatus for checking the tightness of a tank system of an internal combustion engine, in particular of a motor vehicle, by means of underpressure furnished by an intake tube of the engine, the apparatus comprises a first controllable valve disposed in a connection between the tank system and an overpressure or underpressure source, a second controllable valve disposed in a connection of the tank system with the ambient air, user input means for inputting a demand for shutoff of the engine, the leak testing being performed at the end of a travel phase of operation of the engine of a motor vehicle that has the engine, and a filter element located on the intake tube of the engine, the filter element suppressing possible emissions from the intake tube into the environment during an after-running phase (dieseling) of the engine, at least the part of the leak testing that generates the underpressure is performed.

17. The apparatus as defined by claim 10, further comprising display unit for displaying an indication during the delay time that the leak testing is being performed and the demand for shutoff of the engine is carried out with a time delay.

18. The apparatus as defined by claim 11, further comprising display unit for displaying an indication during the delay time that the leak testing is being performed and the demand for shutoff of the engine is carried out with a time delay.

19. The apparatus as defined by claim 12, further comprising display unit for displaying an indication during the delay time that the leak testing is being performed and the demand for shutoff of the engine is carried out with a time delay.

20. The apparatus as defined by claim 13, further comprising display unit for displaying an indication during the delay time that the leak testing is being performed and the demand for shutoff of the engine is carried out with a time delay.
